(19) United States
(12) Patent Application Publication
(10) Pub. No.: US 2026/0019951 A1
(43) Pub. Date: Jan. 15, 2026

(54) ADAPTING RESTRICTED TARGET WAKE TIME TO PROVIDE TRAFFIC CLASSIFICATION GRANULARITY

(71) Applicant: Cisco Technology, Inc., San Jose, CA (US)

(72) Inventors: Brian Donald Hart, Sunnyvale, CA (US); Binita Gupta, San Diego, CA (US); Malcolm Muir Smith, Richardson, TX (US)

(21) Appl. No.: 19/265,076

(22) Filed: Jul. 10, 2025

Related U.S. Application Data
(60) Provisional application No. 63/669,566, filed on Jul. 10, 2024.

(51) Int. Cl. H04W 52/02

(52) U.S. Cl. CPC H04W 52/0258

(57) ABSTRACT

Aspects of the present disclosure are directed to modifying use of Restricted Target Wake Up Time Service to restrict broadcasting traffic parameters sets on a per traffic category basis between an access point and an end device in a wireless network. In one aspect, a method includes transmitting, by an access point, a message to an end device connected to the access point, the message identifying for the end device a traffic type restriction policy that the access point has on reporting Restricted Target Wake Time (R-TWT) parameters for a plurality of traffic types; and receiving, from the end device, a separate Broadcast TWT Parameters Set for each one of the plurality of traffic types in accordance with the traffic type restriction policy.

### CROSS REFERENCE TO RELATED APPLICATIONS

This application claims priority to and benefit of U.S. Provisional Application No. 63/669,566 filed on Jul. 10, 2024, the entire content of which is incorporated herein by reference.

### TECHNICAL FIELD

The present disclosure relates to wireless communication standards, and in particular, to modifying use of Restricted Target Wake Up Time Service to restrict broadcasting traffic parameters sets on a per traffic type basis.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a non-AP MLD with affiliated logical entities according to some aspects of the present disclosure.

FIG. 3 illustrates an example architecture 300 in which multi-AP coordination technologies may be practiced according to some aspect of the present disclosure.

FIG. 4 illustrates an example method of signaling traffic type restriction policy to restrict parameter signaling to allowed traffic types when using R-TWT, according to some aspects of the present disclosure.

FIG. 5 illustrates an example method of signaling traffic type restriction policy to restrict parameter signaling to allowed traffic types when using R-TWT, according to some aspects of the present disclosure.

FIG. 6 shows an example of computing system according to some aspects of the present disclosure.

### DETAILED DESCRIPTION

Various embodiments of the disclosure are discussed in detail below using examples. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

Claim language or other language reciting “at least one of”' a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SCo-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### OVERVIEW

Currently, using a single bitmap, an STA aggregates the requirements of multiple traffic categories in one Broadcast TWT Parameters Set and uses, for example, a Traffic Identifier (TID) bitmap to identify parameters for multiple traffic categories to be transmitted according to an agreed upon R-TWT. This aggregation makes it harder to schedule the traffic according to priority in resource-constrained environments. Aspects of the present disclosure are directed to several mechanisms to prevent such aggregation by signaling a traffic type restriction policy to restrict parameter signaling to allowed traffic types (resolution of TID TIDs and/or Access Category (AC) signaling). This can provide a TID and/or AC level granularity, among other options, when using the R-TWT service.

In one aspect, a method includes transmitting, by an access point, a message to an end device connected to the access point, the message identifying for the end device a traffic type restriction policy that the access point has on reporting Restricted Target Wake Time (R-TWT) parameters for a plurality of traffic types; and receiving, from the end device, a separate Broadcast TWT Parameters Set for each one of the plurality of traffic types in accordance with the traffic type restriction policy.

In another aspect, the traffic type restriction policy is a per-Traffic Identifier (TID) restriction, wherein an R-TWT TID bitmap can have at most one bit in the TID bitmap with a value of 1 while remaining bits must be set to 0.

In another aspect, the R-TWT TID bitmap is an uplink R-TWT TID bitmap.

In another aspect, the R-TWT TID bitmap is a downlink R-TWT TID bitmap.

In another aspect, the separate Broadcast TWT Parameters Set is included in a TWT element of a response frame sent from the end device to the access point.

In another aspect, the traffic type restriction policy is a per-Access Category restriction for one or more of uplink R-TWT and downlink R-TWT transmissions.

In another aspect, the traffic type restriction policy restricts reporting each Broadcast TWT Parameters Set for a subset of Traffic Identifiers or a subset of Access Categories.

In another aspect, the method further includes receiving, at the access point and from the end device, a request, wherein, the access point transmits the message in response to the request, and the message is a TWT response frame with a TWT setup command to alternate TWT and indicates the traffic type restriction policy on reporting TWT parameters.

In another aspect, the response includes a status/reason code indicating to the end device that the access point accepts one TID per Broadcast TWT Parameters Set.

In another aspect, the request is a TWT Setup request or a Broadcast TWT Parameters Set with multiple TIDs or multiple ACs.

In one aspect, an access point includes one or more memories having computer-readable instructions stored therein; and one or more processors. The one or more processors are configured to execute the computer-readable instructions to transmit a message to an end device connected to the access point, the message identifying for the end device a traffic type restriction policy that the access point has on reporting Restricted Target Wake Time (R-TWT) parameters for a plurality of traffic types; and receive, from the end device, a separate Broadcast TWT Parameters Set for each one of the plurality of traffic types in accordance with the traffic type restriction policy.

In one aspect, one or more non-transitory computer-readable media includes computer-readable instructions, which when executed by one or more processors of an access point cause the access point to transmit a message to an end device connected to the access point, the message identifying for the end device a traffic type restriction policy that the access point has on reporting Restricted Target Wake Time (R-TWT) parameters for a plurality of traffic types; and receive, from the end device, a separate Broadcast TWT Parameters Set for each one of the plurality of traffic types in accordance with the traffic type restriction policy.

### EXAMPLE EMBODIMENTS

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency call for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further improve reliability and minimize latency to meet the ever-growing demand for the Internet of Things (IoT), high resolution video streaming, low-latency wireless services, wireless Time Sensitive Networking (TSN) etc.

Multiple Access Point (AP) coordination and transmission in Wi-Fi refers to the management of multiple access points in a wireless network to avoid interference and ensure efficient communication between the STA devices and the network. When multiple access points are deployed in a network-for instance in buildings and office complexes-they operate on the same radio frequency, which can cause interference and degrade the network performance. To mitigate this issue, access points can be configured to coordinate their transmissions and avoid overlapping channels.

802.11bn (expected to be marketed and branded as Wi-Fi 8) supports Multiple-Access Point Coordination (MAPC) technologies including Coordinated Time Division Multiple Access (Co-TDMA), Coordinated Spatial Re-Use (Co-SR), Coordinated Restricted Target Wake Time (Co-RTWT), Coordinated Beamforming (Co-BF), etc., to collaborate and coordinate resource allocation for optimized performance. Among different MAPC technologies, Co-RTWT and Co-TDMA have been proposed to be combined for periodic traffic, with known periodic flows exchanged between APs. Typically, inputs to these exchanges come from negotiations for Stream Classification Service (SCS) (where fields in the SCS frames for a flow carrying a QoS Characteristics element flow SCS (QC)) and for Restricted Target Wake Time (RTWT), Deep Packet Inspections (DPI)/traffic pattern classification (e.g., Network Based Application Recognition (NBAR)).

However, often end devices (e.g., STAs defined below) may have more than one type of traffic (e.g., interactive video, streaming video, interactive audio, streaming audio etc.) to send/exchange with an access point and they may do so according to an agreed upon R-TWT schedule with the access point. Different types of traffic may be identified using a corresponding TID and/or AC. Using R-TWT for multiple types of traffic is problematic because an STA may aggregate the requirements of multiple TIDs/AC(s), which makes it harder to schedule the traffic according to priority in resource-constrained environments.

In some instances, a single TWT element can already report multiple Broadcast TWT Parameter Sets, and an RTWT agreement is always signaled using a Broadcast TWT Parameter Set (including extra RTWT-related parameters).

To address use of R-TWT for exchanging TWT parameters of multiple types of traffic, several mechanisms are proposed herein to limit use of R-TWT to broadcasting TWT parameter sets on a per-TID, per-AC, per limited set of TIDs, and/or per limited set of ACs basis. This provides a TID and/or AC level granularity when using R-TWT service.

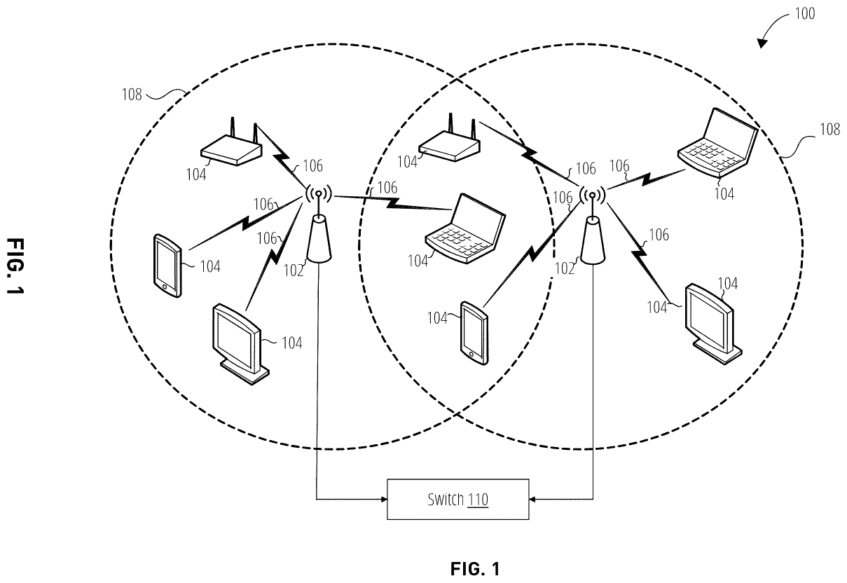

FIG. 1 illustrates a block diagram of an example wireless communication network according to some aspects of the present disclosure.

According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP, which can be one or more of a non-MLD AP, an AP affiliated with an AP MLD, and/or an AP MLD. In the examples presented herein, the AP can exclude an upper UMAC. Therefore, the AP can include the lower UMAC, LMAC, and/or PHY. Additionally, the

WLAN can include one or more of STAs 104, which can be one or more of a non-MLD STA, a STA affiliated with a non-AP MLD, and/or a non-AP MLD. As illustrated, wireless communication network 100 also may include multiple APs such as APs 102 (may also be referred to as simply AP). APs 102 can be coupled to one another through a switch 110. While APs 102 are shown as being coupled to one another through switch 110, wireless communication network 100 can provide another device that allows the coupling of multiple APs. In another example, switch 110 can be a network controller configured to coordinate and manage operations of different APs such as APs 102.

Each of STAs 104 also may be referred to as a mobile station (MS), a mobile device, a mobile handset, a wireless handset, an access terminal (AT), a user equipment (UE), a subscriber station (SS), client, or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STAs 104 can be referred to as clients and/or client devices.

Any one of APs 102 and an associated set of STAs (e.g., STAs 104) may be referred to as a basic service set (BSS), which is managed by a respective AP of APs 102. FIG. 1 additionally shows an example coverage area 108 of the each of APs 102, which may represent a basic service area (BSA) of wireless communication network 100. As illustrated, three of STAs 104 are within the BSA of each of APs 102. The BSS may be identified to users by a service set identifier (SSID), where the BSS might be one of many in the SSID. The BSS may be identified to other devices by a unique (or substantially unique) basic service set identifier (BSSID). One or more of APs 102 periodically broadcasts beacon frames (“beacons”) including the BSSID to enable STAs 104 within a wireless range of one or more of APs 102 to “associate” or re-associate with APs 102 to establish a respective communication link of communication links 106 (hereinafter also referred to as a “Wi-Fi link”), or to maintain communication links 106, with APs 102. For example, the beacons may include an identification of a primary channel used by respective AP of APs 102 as well as a timing synchronization function for establishing or maintaining timing synchronization with APs 102. APs 102 may provide communication links 106 to STAs 104 and therefore access to external networks. While the example has been described in regard to APs 102 and STAs 104, the present disclosure extends such that an AP may provide access to external networks to various STAs in a WLAN via communication links 106.

To establish communication links 106 with any one of APs 102, each of STAs 104 is configured to perform passive or active scanning operations (“scans”) on frequency channels in one or more frequency bands (for example, the 2.4 GHz, 5 GHZ, 6 GHZ, or 60 GHz bands). To perform passive scanning, STAs 104 listen for beacons, which are transmitted by a respective AP of APs 102 at or near a periodic time referred to as the target beacon transmission time (TBTT) (measured in time units (TUs) where one TU may be equal to 1024 microseconds (us)). To perform active scanning, STAs 104 generate and sequentially transmits probe requests on each channel to be scanned and listens for probe responses from APs 102. STAs 104 may be configured to identify or select an AP and thence a selected AP of APs 102 with which to associate based on the scanning information obtained through the passive or active scans, and to perform authentication and association operations to establish the communication links 106 with the selected AP of APs 102. The selected AP of APs 102 assigns an association identifier (AID) to STAs 104 at the culmination of the association operations, which selected AP of APs 102 uses to improve the efficiency of certain signaling to the STAs 104.

The present disclosure modified the WLAN radio and baseband protocols for the PHY and medium access controller (MAC) layers. APs 102 and STAs 104 transmit and receive wireless communications (hereinafter also referred to as “Wi-Fi communications”) to and from one another in the form of PHY protocol data units (PPDUs). APs 102 and STAs 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

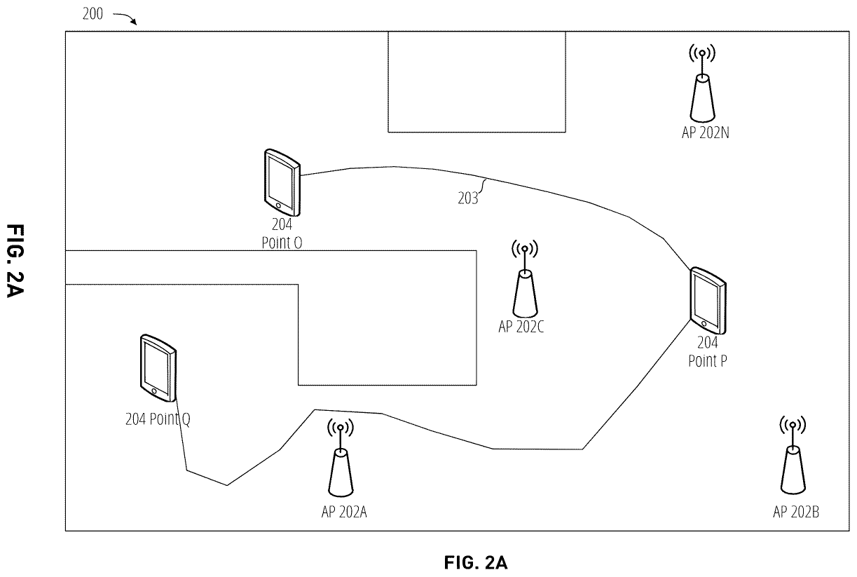

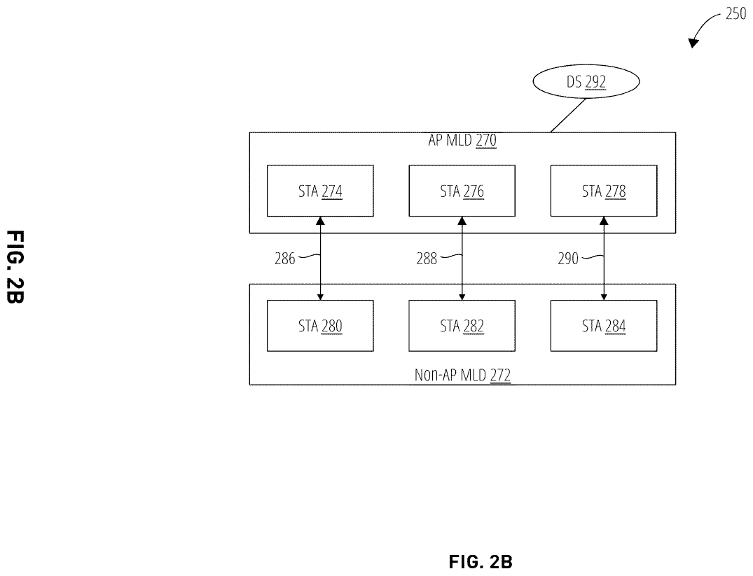

FIG. 2A illustrates an example of a single floor of building equipped with wireless communication according to some aspects of the present disclosure.

While only a single floor 200 is illustrates a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more APs. As illustrated, the single floor 200 includes AP 202A, AP 202B, AP 202C, and AP 202N. Each of the AP 202A, AP 202B, AP 202C, and/or AP 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP of AP 202A, AP 202B, AP 202C, and AP 202N may substantially overlap with the coverage of another AP of the AP 202A, AP 202B, AP 202C, and AP 202N.

As illustrated by line 203, STA 204 can move from point O to point P to point Q. When a STA 204 is moving around on a given floor, one or more of AP 202A, AP 202B, AP 202C, and AP 202N can be considered to be nearest to STA 204. Nearest as used in relation to AP 202A, AP 202B, AP 202C, AP 202N and STA 204 can include being physically nearest (for example, a Euclidean distance on the floor) and/or pathloss-nearest (for example, having the lowest wireless attenuation (pathloss) between a subset of APs, among all the APs, and the STA). Additionally, the pathloss-nearest approach can be used to reduce the likelihood of connection between an AP on a floor above or below STA 204. The location of the AP on the floor above or below might be closer in a Euclidean sense, but also not be a desirable AP for the connection of the device or station due to the floor location and/or possible signal interruption. The location of the AP on the floor above or below might be closer in a straight line and/or Euclidean sense, but also not be a desirable AP for the connection of the device or station due to the floor location and/or possible signal interruption. Additionally, the coverage of one or more APs can at least partially overlap with the coverage of one or more other APs. The present disclosure provides for selecting the AP and/or providing a communication pathway from one or more STA through one or more APs.

FIG. 2B depicts an illustrative schematic diagram for MLO between an AP MLD with affiliated logical entities and a non-AP MLD with affiliated logical entities according to some aspects of the present disclosure.

Referring to FIG. 2B, schematic diagram 250 may include two multi-link logical entities AP MLD 270 and Non-AP MLD 272. AP MLD 270 may include physical and/or logically affiliated AP such as AP 274, AP 276, and AP 278 operating in different channels and typically different frequency bands (e.g., 2.4 GHz, 5 GHZ, and 6 GHZ). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

It should be understood that although the example shows three logical entities within the AP MLD and the three logical entities within the non-AP MLD, this is merely for illustration purposes and that other numbers of logical entities within each of the AP MLD and Non-AP MLD may be envisioned. The example Wi-Fi systems and MLO described above with reference to FIGS. 1 and 2A-2B provide examples of simplified and example systems of the present disclosure.

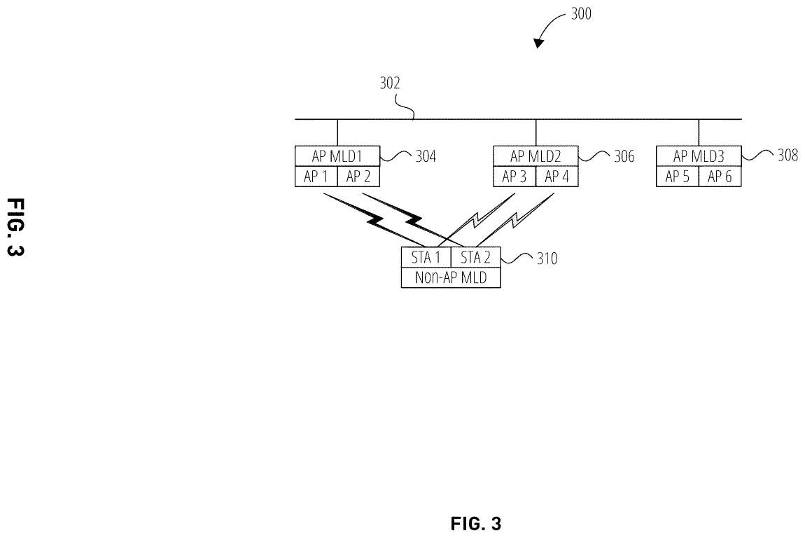

FIG. 3 illustrates an example architecture 300 in which multi-AP coordination technologies may be practiced according to some aspect of the present disclosure.

The architecture 300 includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). Architecture 300 also shows a non-AP MLD 310 that may be connected to AP MLD1 304.

AP MLD1 304 may include one or more APs such as AP1 and AP2. AP1 and AP2 may be different physical APs (or AP interfaces) co-located in AP MLD1 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.).

The non-AP MLD 310 may be any known or to be developed device capable of establishing one or more wireless communication links with one or more of AP MLD1 304, AP MLD2 306, and/or AP MLD3 308. As a non-limiting example, non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of non-AP MLDs and/or STAs associated with each is not limited to that shown in FIG. 3 and may be more or less.

As shown in FIG. 3, the non-AP MLD 310 is associated with the architecture 300 with multiple links set up with the AP MLD1 304 (for example, 2.4 GHz link with the AP1 for the STA 1 and 5 GHz link with the AP2 for the STA 2). For one of the links (for example, 2.4 GHz), the AP MLD1 304 may detect a weak RSSI. As a result, AP MLD1 304 determines a specific roaming target AP3 of AP MLD2 306 for that link to Switch too. Similarly, the same process may be performed for the other link (for example, the 5 GHZ) to Switch to a link with STA 4 on the AP MLD2 205.

As noted earlier, R-TWT is a mechanism by which an AP and a STA agree on a transmission schedule for traffic exchange. It is a mechanism that enhances power saving and determinism/QoS in Wi-Fi networks such as Wi-Fi-7 networks. The R-TWT schedule(s) may be advertised (such as broadcasted) by an AP (e.g., via one or more of Beacon, Probe Response, (Re) Association frames, etc.) or may be individually negotiated and agreed upon between a given AP and a STA (e.g., via TWT Management frames).

In the R-TWT negotiation, a bitmap field per direction (one for uplink, and one for downlink) is transmitted and is used to determine which TIDs are allowed to be transmitted during a given TWT Service Period (SP). Each bitmap field can be a TID traffic category bitmap with 8 bits. Each bit represents one TID among the range 0-7 (i.e., the traffic categories) and TID 0-7 typically map to different QoS traffic categories (e.g., TID 0=Best effort; TID 1=Background; TID 4=Video; TID 6=Voice, etc. For example, a bitmap of 01010000 (most significant bit first) translates to TID 6 (voice) and TID 4 (video) being allowed while all other TIDs are restricted (for the corresponding direction).

An AC refers to one of four defined traffic priority levels used to manage QoS on a wireless medium. It's part of the Enhanced Distributed Channel Access (EDCA) mechanism defined in the IEEE 802.11e amendment. For example, there can be four defined ACs (AC_VO (Voice), AC_VI (Video), AC_BE (Best Effort), and AC_BK (Background). Among these four ACs, AC_VO may have the highest priority while AC_BK may have the lowest priority). The standards define a mapping between each AC and TIDs. An example of such mapping is provided below. By negotiating TIDs in pairs (e.g., TID 6+7 and/or 4+5), the negotiation can be used to establish AC-level granularity per direction.

| AC | Typical Mapped TIDs |
|---|---|
| AC_VO | 6, 7 |
| AC_VI | 4, 5 |
| AC_BE | 0, 3 |
| AC_BK | 1, 2 |

Currently, using a single bitmap per direction (UL or DL), an STA aggregates the requirements of multiple categories of traffic in one Restricted TWT Parameters Set and uses, for example, a Traffic Identifier (TID) bitmap to identify parameters for multiple categories of traffic to be transmitted according to an agreed upon R-TWT. This aggregation makes it harder to schedule the traffic according to priority in resource-constrained environments.

Several mechanisms are described below to prevent such aggregation and enable improved transmission scheduling for traffic transmission between APs and STAs.

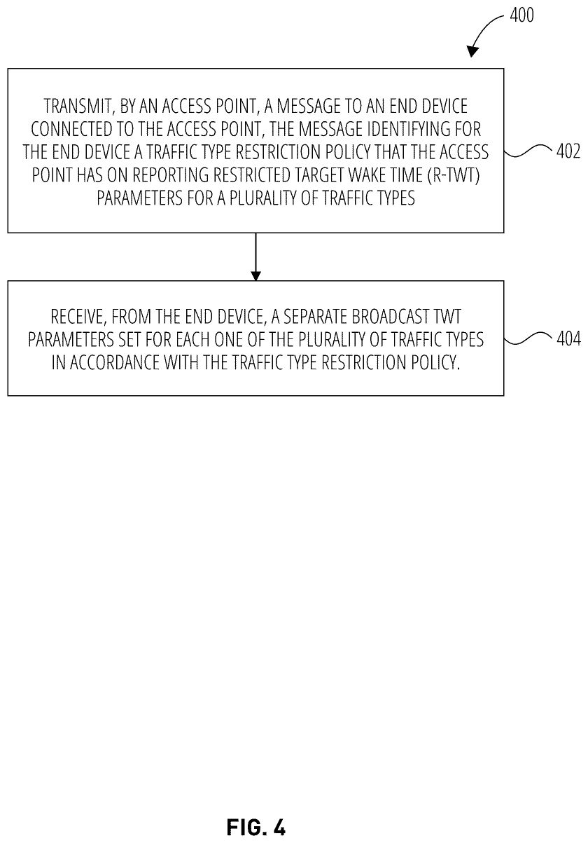

FIG. 4 illustrates an example method of signaling traffic type restriction policy to restrict parameter signaling to allowed category types when using R-TWT, according to some aspects of the present disclosure.

Steps of FIG. 4 may be performed by any given access point (e.g., any one of APs 102, AP MLD 304, AP MLD 306, AP MLD 308, etc.) and/or alternatively by a centralized controller (e.g., switch 110 functioning as an overlay control component for managing operations of APs 102, which act as “dumb pipes”).

According to example process 400, at step 402, the access point may transmit a message to an end device (e.g., one of STAs 104, STA 204, non-AP MLD 310) connected to the access point. In one example, the message informs the end device that the access point has a traffic type restriction policy on reporting R-TWT parameters for a plurality of traffic categories and/or informs the end device what the policy is if the policy has more options than off and on.

In one example, traffic type restriction policy may be indicated in a field in an element or by virtue of the presence of an element (e.g., UHR Operation element) in one or more of Beacon, Probe Response, (Re) Association Response frames, etc.).

In one example, the traffic type restriction policy may specify that the TID bitmap (R-TWT TID bitmap) be a ‘one-hot’ at most. This means that at most one bit in the TID bitmap (e.g., one of bits 0-7) may be set to ‘1’ while all other bits may be set to ‘0’. In this instance, the bit that is set to ‘1’ corresponds to the TID that is permitted to be transmitted according to the TWT schedule. Therefore, if the end device attempts to use R-TWT for multiple TIDs, the end device will have to send multiple Broadcast TWT Parameter Sets in a TWT element (e.g., one Parameter Set per TID).

In one example, the traffic type restriction policy may apply individually to Uplink (UL) and Downlink (DL) R-TWT TID bitmaps (i.e., R-TWT UL TID bitmap and/or R-TWT DL TID bitmap) or the one policy applies to both bitmaps.

After transmitting (signaling) the traffic type restriction policy to the end device, at step 404, the access point may receive a separate Broadcast TWT Parameters Set for each one of the plurality of traffic categories (each one of multiple TIDs) in accordance with the traffic type restriction policy, if the end device decides to use R-TWT for the multiple TIDs. While a separate Broadcast TWT Parameters Set is used as a specific example here, the present disclosure is not limited thereto. Any known or to be developed mechanism for signaling transmission parameters on a per-traffic category in accordance with the traffic type restriction policy.

Step 402 and 404 have been described with reference to specific example where the traffic type restrictions provides a per-TID restriction. However, example embodiments are not limited to just a per-TID restriction. In another example, the traffic type restriction policy may introduce a per-AC restriction policy such as that at most one AC may be permitted. In case of a per-AC restriction policy and because each AC may be associated with more than one TID (e.g., per the table above), a Broadcast TWT Parameter Set sent at step 404 may aggregate the requirements for all TIDs associated with the permitted AC.

In another example, the traffic type restriction policy may be a per-AC and per-TID restriction policy such that for TIDs associated with a permitted AC, a separate Broadcast TWT Parameter Set is included in the TWT element.

In another example, the traffic type restriction policy may specify that the TID bitmap (R-TWT TID bitmap) be ‘limited-hot’ at most. For example, only two or three or four bits may be set to ‘1’ while other bits are set to ‘0’. In other words, the restriction may allow for a subset of all possible TIDs to be aggregated into a Broadcast TWT Parameter set but not all TIDs. In another example, the traffic type restriction policy may specify a limited set of ‘allowed’ ACs (e.g., AC_VO and AC_VI). In another example, the traffic type restriction policy may specify a combination of ‘limited-hot’ TID bitmaps and limited set of ‘allowed’ ACs.

Not-limiting examples of traffic type restriction policy may be as follows. In one example, the traffic type may be TID as described above. In this instance, the traffic type restriction policy may be one TID per Broadcast TWT Parameters Set at max. In other words, the end device needs to send one Broadcast TWT Parameters Set per TID of interest.

In another example, the traffic type may be a set of TIDs of an AC. In this instance, the traffic type restriction policy may be one AC per Broadcast TWT Parameters Set at max. In other words, the end device needs to send one Broadcast TWT Parameters Set per AC of interest.

In another example, the traffic type may TIDs of an AC. In this instance, the traffic type restriction policy may be two ACs per Broadcast TWT Parameters Set at max. In other words, the end device needs to send one Broadcast TWT Parameters Set per AC-pair of interest.

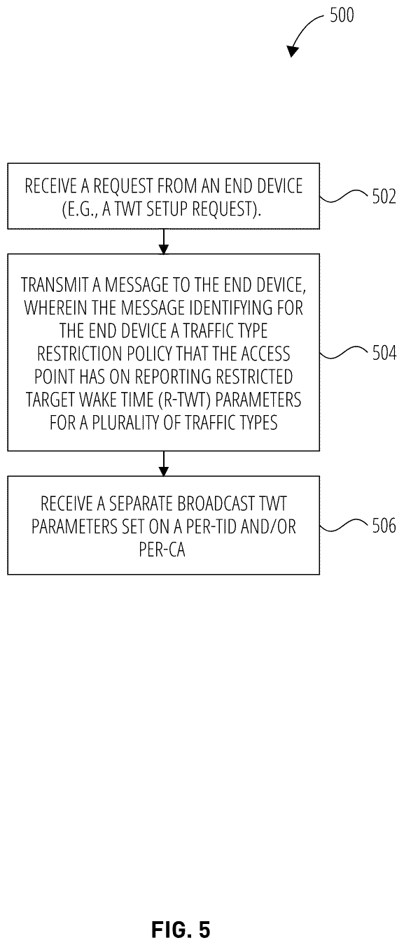

Example embodiments described with reference to FIG. 4 cover what may be referred to as a ‘proactive’ approach, whereby the access point initiates the process of announcing access point's traffic type restriction policy via an element (e.g., UHR Operation element) in one or more of Beacon, Probe Response, (Re) Association Response frames, etc.). However, the present disclosure is not limited thereto. There may also be a ‘reactive’ approach where the end device initiates the TWT process by transmitting, for example, a TWT Request frame to the access point and in response, access point signals the traffic type restriction policy. This ‘reactive’ approach is described below with reference to FIG. 5.

FIG. 5 illustrates an example method of signaling traffic type restriction policy to restrict parameter signaling to allowed traffic types when using R-TWT, according to some aspects of the present disclosure.

Steps of FIG. 5 may be performed by any given access point (e.g., any one of APs 102, AP MLD 304, AP MLD 306, AP MLD 308, etc.) and/or alternatively by a centralized controller (e.g., switch 110 functioning as an overlay control components for managing operations of APs 102).

According to example method 500, at step 502, an access point may receive a request from an end device (e.g., one of STAs 104, STA 204, non-AP MLD 310). The request may be a TWT Setup request.

In response to receiving the request, at step 504, the access point may transmit a message to the end device. In one example, the message informs the end device that the access point has a traffic type restriction policy on reporting TWT parameters for a plurality of traffic categories when using R-TWT service.

In one example, the message may include a specification of a traffic type restriction policy. An example of such message may be a TWT Response, wherein, in a TWT element with TWT Request set to ‘0’, the access point may set the TWT Setup Command to Alternate TWT and indicate one TID in TID bitmaps (e.g., for UL TID bitmap and/or DL TID bitmap) per Broadcast TWT Parameter Sets.

In another example, in addition to sending a TWT Response with TWT Setup Command set to Alternate TWT, the TWT Setup frame may further be enhanced to include an element that contains a status/reason code to indicate a reason (e.g., that the access point accepts one TID per Broadcast TWT Parameters Set, or TIDs of one AC (or a subset thereof) or TIDs of two adjacent ACs (or a subset thereof) or TIDs of highest priority ACs AC_VO and AC_VI (or a subset thereof)).

At step 506 and in response to sending the TWT response from the access point, the access point may receive a separate Broadcast TWT Parameters Set on a per-TID and/or per-AC basis (or other bases as described above) in a similar manner as described above with reference to step 404 of FIG. 4.

In another example, the message received at step 502 may be a Broadcast TWT Parameters Set for multiple TIDs and/or multiple ACs. In response to this message, TWT Setup frame may be enhanced to include an element allowing the access point to signal to the end device a status/reason code (e.g., rejecting Broadcast TWT Parameters Set because the access point accepts one TID per Broadcast TWT Parameters Set). Subsequent to or in conjunction with the status/reason code, the access point may transmit the response described with reference to step 504.

Example embodiments of FIGS. 4 and 5 have been described from the perspective of an access point. However, example embodiments described herein can also be described from the perspective of the end device (e.g., a STA), with logical modifications to steps of FIGS. 4 and 5 (e.g., receiving, by the end device, a message at step 402 instead of transmitting, by the access point a message, and so on).

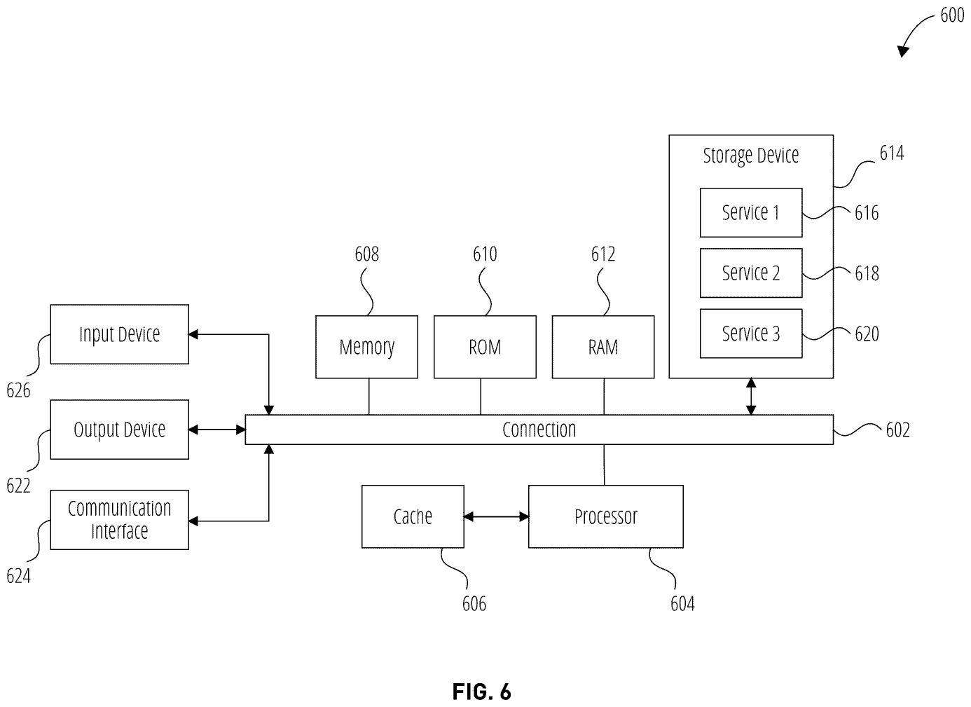

FIG. 6 shows an example of computing system according to some aspects of the present disclosure.

For example, computing system 600 may be any component of wireless communication network 100 and settings shown in FIGS. 1-3 such as APs 102, switch 110 (controller), STAs 104, APs and devices shown in FIGS. 2A and 2B, AP MLD 1 304, AP MLD 2 306, AP MLD 3 308, non-AP MLD 310, and/or any component of thereof. Various components of computing system 600 may be in communication with each other using connection 602. Connection 602 can be a physical connection via a bus, or a direct connection into processor 604, such as in a chipset architecture. Connection 602 can also be a virtual connection, networked connection, or logical connection.

In some examples, computing system 600 is a distributed system in which the functions described in this disclosure can be distributed within a datacenter, multiple data centers, a peer network, etc. In some embodiments, one or more of the described system components represents many such components, each performing some or all of the function for which the component is described. In some embodiments, the components can be physical or virtual devices.

Example computing system 600 includes at least one processing unit (CPU or processor) such as processor 604 and connection 602 that couples various system components including system memory 608, such as read-only memory (ROM) such as ROM 610 and random access memory (RAM) such as RAM 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program or a collection of programs that carry out a specific function. In some embodiments, a service can be considered a server. The memory can be a non-transitory computer-readable medium.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method comprising:
transmitting, by an access point, a message to an end device connected to the access point, the message identifying for the end device a traffic type restriction policy that the access point has on reporting Restricted Target Wake Time (R-TWT) parameters for a plurality of traffic types; and
receiving, from the end device, a separate Broadcast TWT Parameters Set for each one of the plurality of traffic types in accordance with the traffic type restriction policy.

2. The method of claim 1, wherein the traffic type restriction policy is a per-Traffic Identifier (TID) restriction, wherein an R-TWT TID bitmap can have at most one bit in the TID bitmap with a value of 1 while remaining bits must be set to 0.

3. The method of claim 2, wherein the R-TWT TID bitmap is an uplink R-TWT TID bitmap.

4. The method of claim 2, wherein the R-TWT TID bitmap is a downlink R-TWT TID bitmap.

5. The method of claim 1, wherein the separate Broadcast TWT Parameters Set is included in a TWT element of a response frame sent from the end device to the access point.

6. The method of claim 1, wherein the traffic type restriction policy is a per-Access Category restriction for one or more of uplink R-TWT and downlink R-TWT transmissions.

7. The method of claim 1, wherein the traffic type restriction policy restricts reporting each Broadcast TWT Parameters Set for a subset of Traffic Identifiers or a subset of Access Categories.

8. The method of claim 1, further comprising:
receiving, at the access point and from the end device, a request, wherein,
the access point transmits the message in response to the request, and
the message is a TWT response frame with a TWT setup command to alternate TWT and indicates the traffic type restriction policy on reporting TWT parameters.

9. The method of claim 8, wherein the response includes a status/reason code indicating to the end device that the access point accepts one TID per Broadcast TWT Parameters Set.

10. The method of claim 8, wherein the request is a TWT Setup request or a Broadcast TWT Parameters Set with multiple TIDs or multiple ACs.

11. An access point comprising:
one or more memories having computer-readable instructions stored therein; and
one or more processors configured to execute the computer-readable instructions to:
transmit a message to an end device connected to the access point, the message identifying for the end device a traffic type restriction policy that the access point has on reporting Restricted Target Wake Time (R-TWT) parameters for a plurality of traffic types; and
receive a separate Broadcast TWT Parameters Set for each one of the plurality of traffic types in accordance with the traffic type restriction policy.

12. The access point of claim 11, wherein the traffic type restriction policy is a per-Traffic Identifier (TID) restriction, wherein an R-TWT TID bitmap can have at most one bit with a value of 1 while remaining bits must be set to 0.

13. The access point of claim 12, wherein the R-TWT TID bitmap is an uplink R-TWT TID bitmap.

14. The access point of claim 12, wherein the R-TWT TID bitmap is a downlink R-TWT TID bitmap.

15. The access point of claim 11, wherein the separate Broadcast TWT Parameters Set is included in a TWT element of a response frame sent from the end device to the access point.

16. The access point of claim 11, wherein the traffic type restriction policy is a per-Access Category restriction.

17. The access point of claim 11, wherein the traffic type restriction policy restricts reporting each Broadcast TWT Parameters Set for a subset of Traffic Identifiers or a subset of Access Categories.

18. The access point of claim 11, wherein the one or more processors are further configured to execute the computer-readable instructions to:
receive, from the end device, a request, wherein,
the access point is configured to transmit the message in response to the request, and
the message is a TWT response frame with a TWT setup command to alternate TWT and indicates the traffic type restriction policy on reporting TWT parameters.

19. The access point of claim 18, wherein the response includes a status/reason code indicating to the end device that the access point accepts one TID per Broadcast TWT Parameters Set.

20. The access point of claim 18, wherein the request is a TWT Setup request or a Broadcast TWT Parameters Set with multiple TIDs or multiple ACs.
